(19) United States
(12) Patent Application Publication
(10) Pub. No.: US 2019/0133057 A1
(43) Pub. Date: May 9, 2019

(54) CENTER-CUT STUMP GRINDER WITH WIDE LATERAL REACH

(71) Applicant: BARRETO MANUFACTURING, INC., LA GRANDE, OR (US)

(72) Inventor: GREG BARRETO, LA GRANDE, OR (US)

(21) Appl. No.: 16/045,691

(22) Filed: Jul. 25, 2018

Related U.S. Application Data
(63) Continuation-in-part of application No. 14/932,269, filed on Nov. 4, 2015, now abandoned.
(60) Provisional application No. 62/075,234, filed on Nov. 4, 2014.

(51) Int. Cl. A01G 23/06

(52) U.S. Cl. CPC A01G 23/067

(57) ABSTRACT

A powered stump grinder at the center front of a walk-behind machine is disclosed. The grinder machine has a front cutter head assembly pivotally connected to the walk-behind machine by a central pivot assembly connected to the center front part of the frame or body of the machine. The central pivot assembly includes a vertical pivot axle/axis, for lateral movement of the connected front cutter head assembly. Generally horizontal hydraulic cylinders, extending between a frame or body of the stump grinder and left and right lateral portions of the pivot assembly, pivot horizontally and extend and retract to control lateral movement of the connected front cutter head assembly by pivoting the pivot assembly, which in turn pivots the connected cutter arm, and hence, the cutter head assembly.

This application is a continuation-in-part of Non-Provisional application Ser. No. 14/932,269, filed Nov. 4, 2015, which claims priority of U.S. Provisional Application Ser. No. 62/075,234, filed Nov. 4, 2014, the entire disclosures of both applications being incorporated herein by this reference.

### BACKGROUND OF THE DISCLOSED TECHNOLOGY

### Field of the Disclosed Technology

This invention relates generally to powered tools for removing tree stumps by chipping, grinding or sawing. More specifically, this invention relates in one embodiment to a pivot head assembly of a stump grinder machine for supporting and controlling a cutter head assembly so that the cutter head can reach out from the front of the machine, and move up and down, and also from side to side, to operate effectively on the stump to be removed. Preferably, the pivot head assembly is mounted and secured to the stump grinder machine for enabling lateral rotation/swinging of the cutter head assembly about a generally vertical axis preferably located near the center of the front of the grinder machine.

### Related Art

For stump grinders, the industry has one general version which has a grinder head on one lateral side for easier viewing by the operator. The industry has another general version which has a grinder head located centrally which is pivoted back and forth, in effect, to sweep away the tree stump to be removed.

U.S. Pat. No. 3,198,224 (Hiley) is one example of the grinder head being located centrally, and rotated horizontally back-and-forth, in this case, at the rear end of a tractor. Two horizontal hydraulic cylinders and pistons pushing/pulling directly on a pivot head obtain about 80° of rotation of a connected, extending boom.

U.S. Pat. No. 3,336,958 (Carlton) is one example of a grinder head being on one lateral side, with one wheel of a grinding machine being turned while the other wheel is fixed to rotate the grinder head horizontally.

U.S. Pat. No. 5,718,271 (Engelhoven) is one example of a grinder head being moved by a backhoe arm of a construction tractor which has a central boom which supports and controls a grinder head.

U.S. Pat. No. 5,829,497 (Maroney) is one example of a grinder head being moved by first and second hydraulic cylinder and piston units in a frame supported by the three point hitch of an agricultural tractor.

U.S. Pat. No. 6,435,234 (Paumier) is one example of a grinder head being swept horizontally as a result of the rotation of a central cab containing a boom which supports and controls a grinder head.

U.S. Pat. No. 7,150,300 (Peterson) is one example of a tilting grinder head being swept horizontally as a result of the rotation of a central boom which holds and controls a grinder head.

US Published Patent Application #2009/0101234 (Hart) is one example of a grinder head being held and supported by a central boom which also holds and supports a central power unit, in this case an internal combustion engine.

US Published Patent Application #2012/0175018 (Knipp et al.) is another example of a grinder head being on one lateral side of a grinder machine.

### SUMMARY OF THE DISCLOSED TECHNOLOGY

This invention is an improved stump grinder machine with a central pivot head assembly mounted and secured near the center of the front of the grinder machine for supporting and controlling the cutter head assembly. In this respect, the present machine is referred to as a “center-cut” stump grinder. In contrast, different versions of a “side-cut” grinder machine are disclosed in U.S. Pat. No. 3,336,958 (Carlton), and U.S. Published Patent Application #2012/0175018 (Knipp et al.), discussed above. In the “side-cut” machine, a pivot head assembly is mounted offset, more to one side than the other side of the front of a grinder machine.

According to a preferred embodiment of the present invention, the back part of the central pivot head assembly is mounted at or near a center front part of the grinder machine's frame or body, preferably via a mounting plate. The mounting plate secures and supports the back part of the pivot head assembly, which pivot head assembly rotates about a generally vertical axis. The mounting plate also supports on its top a pair of generally horizontal, lateral hydraulic cylinders, one for connection with the piston or ram thereof to each lateral side of the pivot head assembly, which lateral cylinders and rams act to turn the pivot head assembly from side-to-side by extending on one side and retracting substantially simultaneously on the other side.

Certain embodiments are adapted for increased side-to-side/lateral swinging/pivoting of the cutter head assembly, by special adaptation of the central pivot head assembly between the cutter head assembly and the main body and special adaptation of the hydraulic cylinders performing the swinging/pivoting. The central pivot head assembly comprises a structural connection that angles outwardly from its back to its front so that the back is narrower than the front thereof. Further, each of the horizontal or generally horizontal, lateral-swing hydraulic cylinders is preferably pivotally connected on a vertical axis to the main body, so that, during extension and retraction, each cylinder horizontally also pivots to increase the amount of lateral-swing/pivot of the cutter head assembly. These adaptations allow and cause the cutter head assembly to pivot horizontally greater than 120 degrees relative to the main body of the stump grinder machine, for example, to have a “sweep range” of about 135° at the front of the machine.

Therefore, the front cutting head assembly, which is attached to the pivot head assembly, may be effectively rotated horizontally/swung laterally in a wide arc to engage at least the complete width of even a large stump to be ground, or even engage several stumps sequentially without having to move the whole grinder machine to another location, and/or to effectively reach a stump with the cutting head assembly even when adjacent structure (such as surrounding buildings, fences, rocks, trees or landscaping, for example) limits the locations in which the main body of the machine can be placed.

The front part of the central pivot head assembly supports a more vertical central hydraulic cylinder which extends forwardly therefrom, and the piston or ram of which connects to a generally central part of the cutting head assembly. The front part of the pivot head assembly also supports the back part of the cutting head assembly on a generally horizontal, transverse axis. This way, as the ram of the central hydraulic cylinder extends forwardly and down, the cutting head assembly extends outwardly and rotates vertically down to engage the stump to be ground. Likewise, as the more vertical central cylinder retracts rearwardly and up, the cutting head assembly retracts inwardly and rotates vertically upwardly to disengage from the stump, and for transport.

### BRIEF DESCRIPTION OF THE DRAWINGS

FIG. 1 is a schematic, partial, right side view of one embodiment of the subject stump grinder machine, with the cutting head assembly extended centrally and downwardly.

FIG. 2 is the view of FIG. 1, but with the cutting head assembly extended upwardly.

FIG. 3 is a top, right side, schematic perspective view of the embodiment depicted in FIG. 1, but with the cutting head assembly rotated horizontally or pivoted laterally to the right of the center of the grinder machine.

FIG. 4 is the view of FIG. 3, but with the cutter head assembly rotated horizontally or pivoted laterally to the left of the center of the grinder machine.

FIG. 5 is a schematic, complete, top view of the embodiment depicted in FIG. 3.

FIG. 6 is a schematic, complete, top view of the embodiment depicted in FIG. 4. From FIGS. 5 and 6 it may be seen that the cutter head assembly for the subject stump grinder machine may pivot to rotate laterally left and right in a total arc of about 135°.

FIG. 7 is a schematic, left side, top perspective view of one embodiment of the subject stump grinder machine. In FIG. 7, the list of numbered parts refers to the circled, numbered items in FIG. 8, below. In FIG. 7, the “Options; BS/K” notation refers to the optional Briggs & Stratton Co. and Kohler Co. engines available.

FIG. 8 is a schematic, partially exploded view of the embodiment depicted in FIG. 7, with certain parts numbered according to the table beside FIG. 7.

FIG. 9 is a detail view of the cutter head assembly depicted in FIG. 8. In FIG. 9, the list of numbered parts refers to the circled, numbered items in FIG. 10, below.

FIG. 10 is a schematic, exploded view of the cutter head assembly depicted in FIG. 9, with certain parts numbered according to the table above FIG. 9.

FIG. 11 is a schematic, exploded, top, left perspective detail view of the mounting plate and pivot head assembly depicted in FIG. 8, with certain parts numbered according to the table beside FIG. 11.

FIG. 12 is a view like FIG. 7, but of a slightly different embodiment with a slightly different control assembly (part #24), and an additional chip shield (part #31). In FIG. 12, the list of numbered parts refers to the circled, numbered items in FIG. 13, below.

FIG. 13 is a view like FIG. 8, but of the different embodiment depicted in FIG. 12. The outlined part of FIG. 13 is partially depicted in FIG. 14, below (except the chip shield, part #31, which is not shown in FIG. 14).

FIG. 14 is a schematic, enlarged detail view of the outlined (encircled) part of FIG. 13 (except the chip shield, part #31). Also, in FIG. 14 the circled, numbered items of FIG. 13 have been removed, and the call-out numbers from the DETAILED DESCRIPTION, below, have been added.

FIG. 15 is a right side view of another embodiment of the subject stump grinder machine, with the cutting head assembly extended centrally and downwardly.

FIG. 16 is the view of FIG. 15, but with the cutting head assembly extended upwardly.

FIG. 17 is a top, right side perspective view of the embodiment depicted in FIG. 15, but with the cutting head assembly rotated horizontally or pivoted laterally to the right of the center of the grinder machine.

FIG. 18 is the view of FIG. 17, but with the cutter head assembly rotated horizontally or pivoted laterally to the left of the center of the grinder machine.

FIG. 19 is a top view of the embodiment of FIG. 15, with the cutter head assembly rotated horizontally or pivoted laterally to the right of the center of the grinder machine as in FIG. 17, but with components directly above the lateral-swing cylinders in FIG. 15 removed from this view to better show the cylinders.

FIG. 20 is the view of FIG. 19, but with the cutter head assembly rotated horizontally or pivoted laterally to the left of the center of the grinder machine as in FIG. 18, and with said components directly above the lateral-swing cylinders in FIG. 15 removed from this view to better show the cylinders. From FIGS. 19 and 20 it may be seen that the cutter head assembly for this stump grinder machine may pivot to rotate laterally left and right in a total arc of about 135°.

FIG. 21 is a left side, top perspective view of another embodiment of the subject stump grinder machine. In FIG. 21, the list of numbered parts refers to the circled, numbered items in FIG. 22, below. In FIG. 21, the “Options” notation refers to optional Briggs & Stratton Co. and Kohler Co. engines available.

FIG. 22 is a partially exploded view of the embodiment depicted in FIG. 21, with certain parts numbered according to the table beside FIG. 21.

FIG. 23 is an enlarged view of the cutter head assembly depicted in FIGS. 21 and 22. In FIG. 23, the list of numbered parts refers to the circled, numbered items in FIG. 24, below.

FIG. 24 is an exploded view of the cutter head assembly depicted in FIG. 23, with certain parts numbered according to the table above FIG. 23.

FIG. 25 is an exploded, top, left perspective detail view of selected components from the views of FIGS. 21 and 22, namely, the central pivot head assembly, the pivotal cylinder system comprising two cylinders that laterally swing the pivot head assembly, and a mounting plate for lateral-pivotal connection of the central pivot head assembly and the two pivotal cylinders, and with certain parts numbered in this view according to the table beside FIG. 25 and central pivot head assembly 320, with plates 341, 342, and 344 visible and labeled in this view.

FIG. 26 is an enlarged detail view of selected components of the views of FIGS. 21 and 22, namely, the cutter head assembly, the central pivot head assembly, a frame portion of the main body of the machine, the mounting plate for being fixed to the frame portion for lateral-pivotal connection of the central pivot head assembly to the frame portion, and the pivotal cylinder system that laterally swings the pivot head assembly and consequently the cutter head assembly relative to the frame portion.

### DETAILED DESCRIPTION OF CERTAIN EMBODIMENTS OF THE DISCLOSED TECHNOLOGY

In a preferred embodiment, a powered, walk-behind stump grinder machine is disclosed. The grinder machine has a front cutter head assembly pivotally connected to a central pivot assembly adapted for horizontal/generally-horizontal, or “lateral”, pivoting, so that the attached front cutter head assembly also pivots horizontally, relative to the main body of the machine, the pivot assembly and the ground, on a generally vertical axis. The pivot assembly is, in turn, at a back part thereof securely and pivotally connected to the center front part of an optional mounting plate that is securely connected to the front of the frame (or “frame portion”) or other portion of the main body of the machine. The pivot assembly may be temporarily secured to the frame/main body of the machine via a removable mounting plate. Two generally horizontal hydraulic cylinders on the mounting plate have rams connected to the pivot assembly, one on each lateral side of the generally vertical axis for the pivot assembly, to control the lateral movement of the pivot assembly and the attached front cutter head assembly. In addition, the central pivot assembly preferably is also adapted for vertical/generally-vertical, or “up and down”, pivoting of the cutter head assembly, relative to the main body of the machine, the pivot assembly, and the ground, on a generally horizontal axis. A more vertical hydraulic cylinder mounted on the pivot assembly has a ram which connects to and controls said vertical/generally-vertical movement of the front cutter head assembly.

Referring specifically to the Figures, there are depicted several preferred, but not all, embodiments of the subject stump grinder machine.

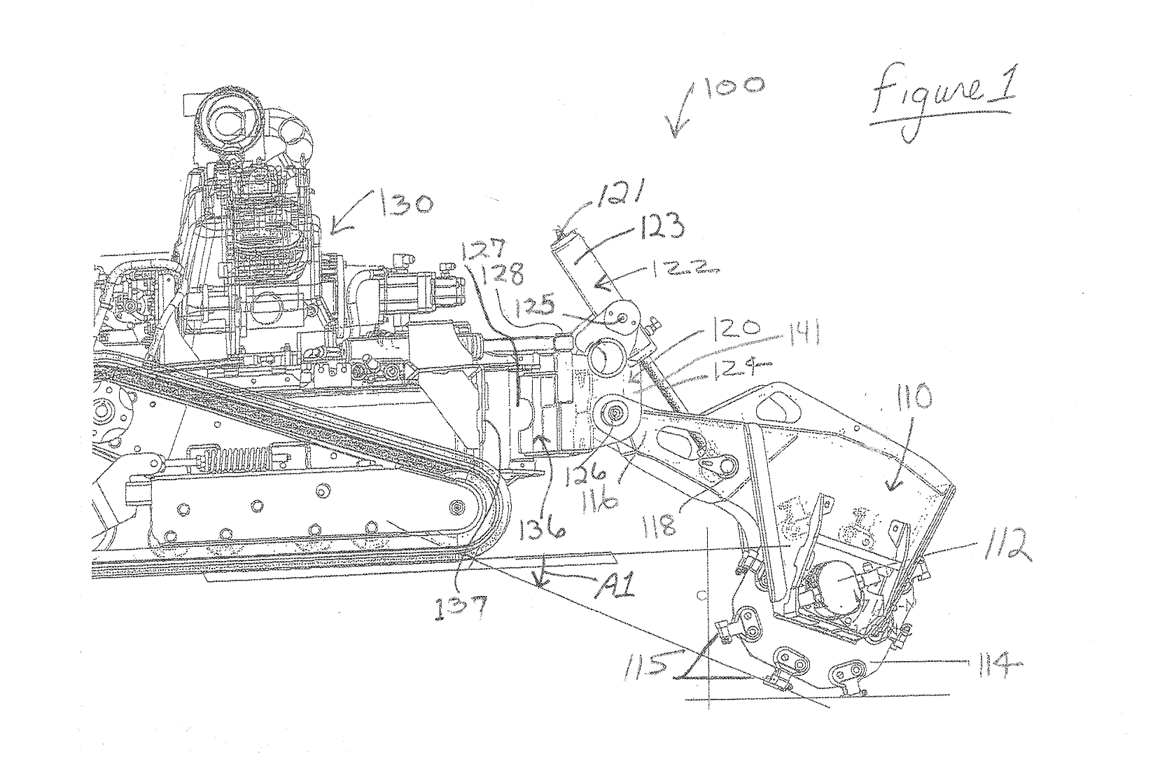

FIG. 1 depicts a schematic, partial right-side view of one embodiment of the subject stump grinder machine. Stump grinder 100 has front cutter head assembly 110, middle or central pivot head assembly 120, and back, powered, walk-behind assembly 130 that is one example of a “main body” of the machine. Front cutter head assembly 110 has powerful hydraulic motor 112 on its front part which rotates cutting wheel 114 at high speed so that cutting teeth 115 thereon may contact and grind the stump. These parts, motor 112, wheel 114 and teeth 115 of the front part of cutter head assembly 110, may be of conventional design and manufacture, including, for example, a powerful electrical motor.

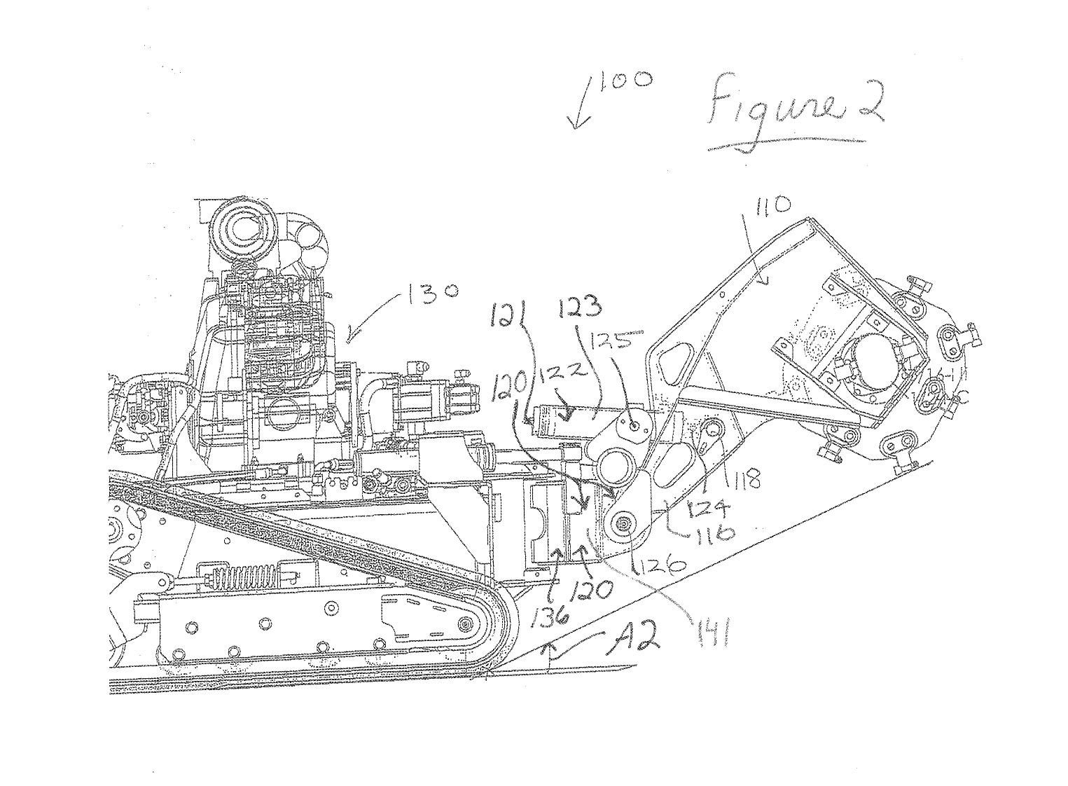

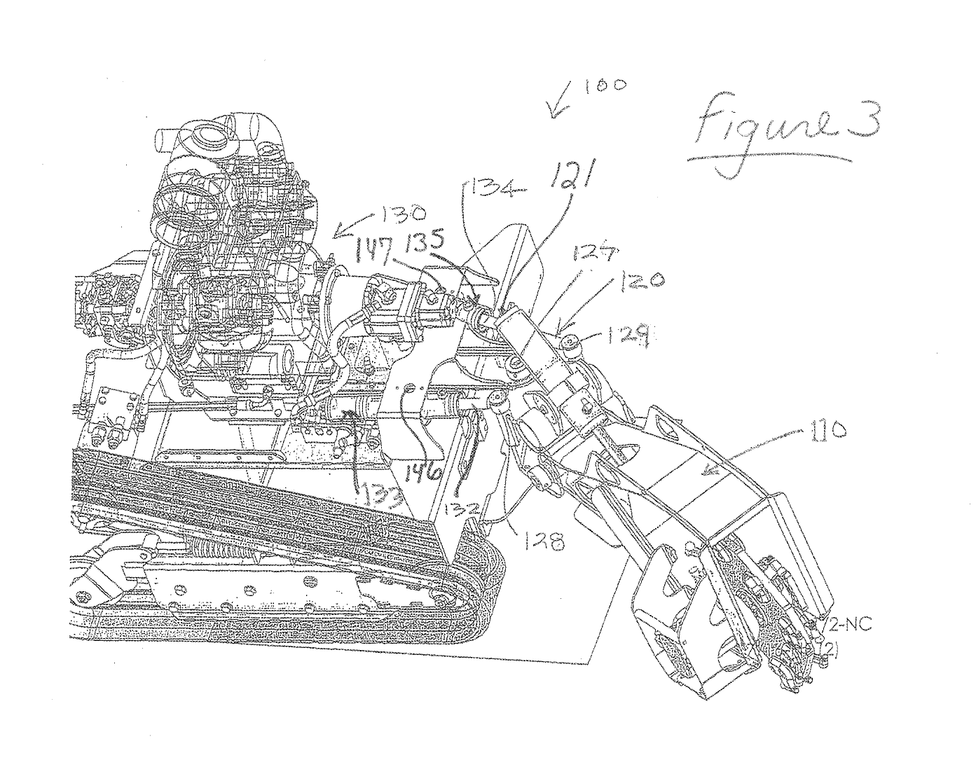

The back part of cutter head assembly 110 has cutter arm 116 for pivotally connecting to the central pivot head assembly 120 at cutter arm horizontal pivot axle/axis 126. On cutter arm 116 forward of axle/axis 126 (but rearward of the cutter head assembly 110), is front generally horizontal hydraulic pivot axle/axis 118, for pivotal connection of the cutter arm 116 to the central hydraulic ram 124 of the “more vertical” central hydraulic cylinder 122. Central hydraulic cylinder 122 is also pivotally connected to central pivot head assembly 120, preferably by cylinder housing 123 being pivotally mounted on assembly 120 at a horizontal pivot axle/axis 125. Therefore, certain embodiments of central hydraulic cylinder 122 may be called a “trunnion cylinder” or a “trunnion-mounted cylinder”. Note that the rear end 121 of cylinder 122 is not mounted or otherwise attached to assembly 120, to cutter head assembly 110, or to any structure, and the housing 123 of cylinder 122 is mounted only by the trunnion-mount at pivot 125 part way between the rear end 121 and the front end of the housing 123. See rear end 121 of the cylinder 122 in FIGS. 1-4. By “more vertical” is meant that hydraulic cylinder 122 and its ram 124 lie and move in a generally more vertical plane compared to the lateral-swing cylinders 133, 135. For example, cylinder 122 and its ram 124 move between the position shown in FIG. 1 (for example, 25-35 degrees, or about 30 degrees, from vertical, for a fully-lowered cutter head assembly 110) and the position shown in FIG. 2 (for example, 3-10 degrees, or about 5 degrees, from horizontal, for a fully-raised cutter head assembly 110), compared to the consistently horizontal or generally horizontal hydraulic cylinders 133 and 135 depicted in, for example, FIG. 3, below. In certain embodiments, the trunnion-mounted cylinder 122 may be described as pivoting on its trunnion-mounting in a vertical plane at least 45 degrees, or at least 50 degrees, or about 55 degrees.

Said moving of cylinder 122 in a vertical plane is accomplished by the pivot axle/axis 118 and pivot axle/axis 125 allowing the entire cylinder 122 to pivot relative to the cutter arm and also relative to the central head assembly 120 during expansion (to the position in FIG. 1) and retraction (to the position in FIG. 2). This way, the extent/degrees of the vertical swing of the cutter head assembly 110 and its cutter arm 116 are greatly increased compared to the extent/degrees that a non-pivoting (non-trunnion-mounted) cylinder could accomplish. This way, effectiveness and maneuverability of the cutting head assembly and the entire machine is increased during use and travel/transport. For example, the extent/degrees of vertical swing may be in the range of 45-70, or more preferably 50-60 degrees. As may be seen in FIGS. 1 and 2, the extent/degrees of vertical swing may be considered the sum of angle A1 and A2, which is about 50 degrees for this embodiment.

Therefore, central pivot head assembly 120 has generally horizontal hydraulic pivot axle/axis 125 so that central hydraulic cylinder 122 may rotate rearwardly (counter-clockwise in FIG. 1) when the cutter head assembly 110 is rotated to lift it upwardly (as in FIG. 2). This happens when central ram 124 is retracted within the housing 123 of central hydraulic cylinder 122. Further, horizontal hydraulic pivot axle/axis 125 allows central hydraulic cylinder 122 to rotate forwardly (clockwise in FIG. 2) to lower the cutter head assembly 110 from the FIG. 2 position back to the FIG. 1 position. This happens when central ram 124 is extended from the housing 123 of central hydraulic cylinder 122. This way, central hydraulic cylinder 122 and its central ram 124 control the elevation of the cutter head assembly 110 by lifting and lowering cutter head assembly 110 about cutter arm horizontal pivot 126 that connects cutter arm 116 to central pivot head assembly 120.

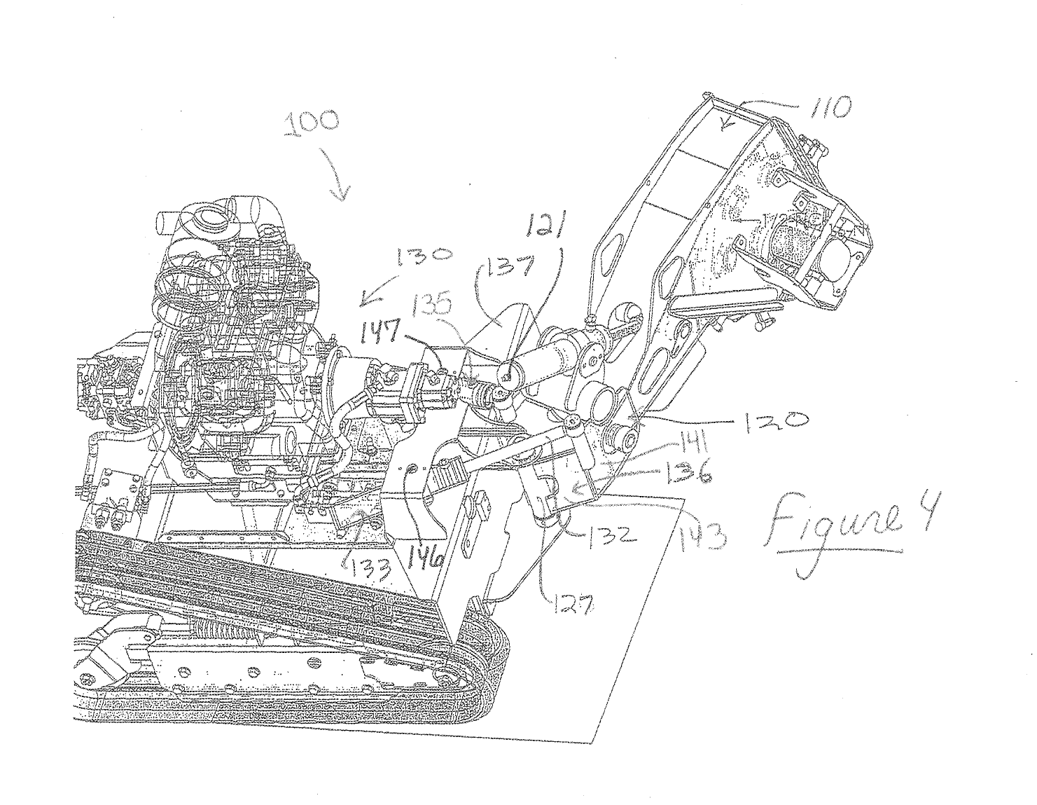

In turn, central pivot head assembly 120 is pivotally connected to back, powered, walk-behind assembly or “main body” 130 via mounting plate 137 by central pivot head vertical pivot axle/axis 127. Mounting plate 137 is further described below in reference to FIG. 4.

FIG. 2 depicts the view of FIG. 1, but with the cutting head assembly 110 lifted to swing outwardly and upwardly. By comparing FIGS. 1 and 2, it may be seen that the lift from the upward rotation of cutting head assembly 110 about the horizontal axes of pivots 118 (connection of ram 124 to the cutter arm 116), 125 (connection of the cylinder 122 to the pivot head assembly 120), and 126 (connection of the cutter arm 116 to the pivot head assembly 120) is caused by the retraction of ram 124 into more vertical central hydraulic cylinder 122.

FIG. 3 depicts a top, right side perspective view of the embodiment of FIG. 1, but with the cutting head assembly 110 rotated to extend laterally to the right of stump grinder 100. In this FIG. 3, central pivot head vertical pivot axle/axis 127, discussed above, is more clearly visible. Also, in this FIG. 3, it is more clearly evident that, besides right side hydraulic pivot 128, there is also left side hydraulic pivot 129. Hydraulic pivots 128 and 129 are both separated from central pivot head vertical pivot axle/axis 127 by a similar or same horizontal distance. By “similar or same horizontal distance” is meant, in the context of conventional manufacturing techniques and tolerances, that pivot 128 and 129 are generally geometrically symmetrical about central pivot head vertical pivot axle/axis 127.

Hydraulic pivots 128 and 129 are connected by right side hydraulic ram 132 and left side hydraulic ram 134, respectively, which rams are connected to right side hydraulic cylinder 133, and to left side hydraulic cylinder 135, respectively. This way, cutter head assembly 110 may be rotated to swing laterally to the right by right side hydraulic ram 132 retracting, while at the same time left side hydraulic ram 134 extending. Likewise, cutter head assembly 110 may be rotated to swing laterally to the left by right side ram 132 extending, while left side ram 134 simultaneously retracting. This way, right side hydraulic cylinder 133 and its ram 132, and left side hydraulic cylinder 135 and its ram 134 control the lateral location of the cutter head assembly by swinging it left and right about the vertical axles/axes of vertical pivot 127, and hydraulic pivots 128 and 129.

FIG. 4 depicts the view of FIG. 3, but with the cutter head assembly 110 extended laterally to the left of stump grinder 100. In this FIG. 4, the bottom part of central pivot head vertical pivot axle/axis 127 is more visible, as is right side hydraulic ram 132 and right side hydraulic cylinder 133. Also, the structural connector 136 between the front part of central pivot head assembly 120 and central pivot head vertical pivot 127 is well visible.

FIG. 4 also depicts mounting plate 137 which optionally connects and secures the back part of central pivot head assembly 120 to the front part of the frame or other portion of powered, walk-behind assembly/main-body 130. Mounting plate 137 may be of a permanent or temporary, that is, conveniently removable, nature. When permanently installed, mounting plate may be integrally formed with, or welded to, for example, the front part of the frame or other portion of walk-behind assembly/main-body 130. When temporarily installed, mounting plate 137 may be effectively secured to walk-behind assembly/main-body 130 by nuts and bolts or other removable fasteners in conventional manner, and therefore be conveniently removable.

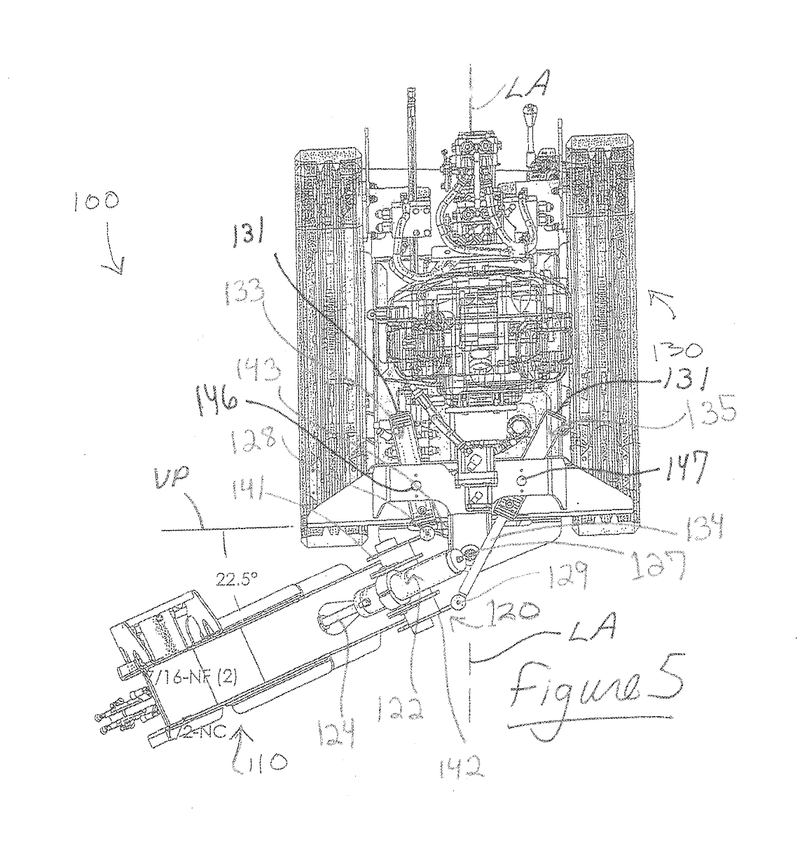

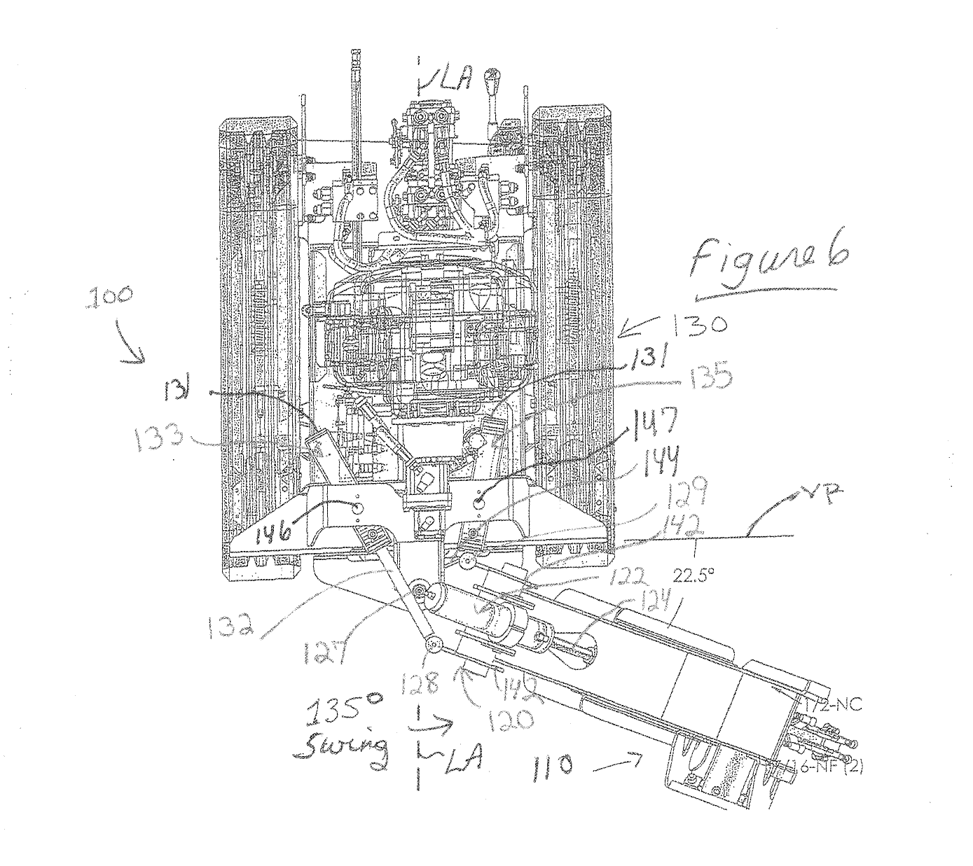

FIGS. 5 and 6 are top views of the subject grinder machine 100, with the cutting head assembly 110 extending laterally to the right of the machine in FIG. 5, and laterally to the left of the machine in FIG. 6. From these Figures it is clear that the cutting head assembly 110 may be swung in an arc between locations at the far right and at the far left of the walk-behind assembly 130. For example, as shown in FIGS. 5 and 6, these locations may correspond to the right side of the cutting head assembly 110 swinging right all the way to about 22.5 degrees from the vertical plane VP of the front of the assembly 130, and the left side of the cutting head assembly 110 swinging left all the way to about 22.5 degrees from the vertical plane VP of the front of the assembly 130. As thus described, it may be said that the cutting head assembly 110 may be swung in an arc of about 135° from the center of the front of the grinder machine 100.

Another way of measuring and describing the lateral movement is to measure the rotation/swing at the centerline of the cutting head assembly 110, and the cutter arm 116, relative to the vertical plane VP of the front of the assembly 130. Thus-measured, it may be also be said that the cutting head assembly 110 may be swung in an arc of about 135 degrees from the center of the front of the grinder machine 100.

The wide lateral rotation/swing of the cutting head assembly 110 preferably is greater than 120 degrees, more preferably in the range of about 120-150 degrees, and most preferably about 130-140 degrees. Depending on the dimensions of the grinder machine, this may correspond to lateral travel of the cutting head in an arc of about 4-8 feet, for example. This corresponds to a far greater rotation/swing than would be necessary to match the diameter of an “average” stump, for example, far greater than ≤60 degrees of rotation/swing and an arc of about ≤2 feet for a 1.5-2 foot diameter stump.

Certain embodiments comprise adaptations, in the central pivot head assembly 120 and the lateral-swing cylinder system comprising cylinders 133 and 135, that serve to enhance and maximize the wide lateral rotation/swing of the cutting head assembly 110. The adaptation of the central pivot head assembly 120 comprises a specially-shaped structural connector 136, and the adaptation of cylinders 133 and 135 comprises each cylinder being pivotal mounted in order to swing horizontally/laterally. There adaptations are further described below.

The central pivot head assembly may be described as comprising right and left parallel plates/walls 141, 142, which comprise/support pivot axle/axis 126 for cutter arm 116 and which connect to and support horizontal pivot axle/axis 125 for cylinder 122, and structural connector 136 that comprises right and left non-parallel plate 143, 144. Right and left non-parallel plates 143, 144 (or the “outermost plates” or the “outermost walls” of the structural connector) are attached at their front portions to right and left parallel plates/walls 141, 142 and attached to or form at their rear portions the sleeve/bearing housing of vertical pivot axle/axis 127. At the corners/intersections of non-parallel plates 143 and 144 with plates 141, 142 are the right and left side hydraulic pivots 128, 129. Non-parallel plates 143, 144 are at an angle to each other, so that the back part/region of the structural connector 136 is narrower than the front part thereof. The structural connector 136 may be described as a triangular shape (in top view), for example, an isosceles triangle with two equal-length plates 143, 144 at an angle to each other in the range of 70-90 degrees, or in the range of 80-90 degrees or about 85 degrees as shown by FIGS. 5 and 6. In other words, the structural connector angles outwardly from its back part to its front part, to create a relatively narrow structural connector rear region for pivot axle/axis 127 and a wider front region for hydraulic pivots 128, 129. This way, the central pivot head assembly can pivot/swing through a wide lateral arc, as discussed elsewhere in this document, due to the triangular structural connector swinging through the wide lateral arc without hitting/abutting against any surrounding structure, and especially without hitting/abutting against the mounting plate 137 or other portion of the main body 130. This wide lateral arc that the cutter head assembly is adapted to pivot horizontally greater than 120 degrees, for example, about 135 degrees.

Right and left cylinders 133 and 135 are pivotally mounted on left and right vertical pivot axles/axes 146, 147, respectively, for example, at a location about midway along the length of their housings 148, 149, or in the range of 30-70 percent, or 40-60 percent, of the way between the ends of the housings 148, 149. Thus, each of cylinders 133 and 135 may be described as a “trunnion cylinder” or a “trunnion-mounted cylinder”. Note that the rear ends 131 of cylinders 133, 135 are not mounted or otherwise attached to main body 130, to mounting plate 137, to central pivot assembly 120, or to any structure, and the housings of cylinders 133, 135 are mounted only by the trunnion-mounts at pivots 146, 147 part way between the rear ends 131 and the front ends of the cylinder housings. See rear ends 131 of the cylinders 133, 135 in FIGS. 5 and 6. Mounting plate 137 comprises apertures and mounts for receiving and/or cooperating with fittings and pins for the trunnion mounting of the cylinders 133, 135. The trunnion mounting of cylinders 133, 135 allows cylinder 133, 135 to pivot in a horizontal or nearly horizontal plane during expansion and retraction. This may be seen by comparing the positions of the cylinders 133, 135 including their respective rams 132, 134, in FIG. 3 versus FIG. 4, and FIG. 5 versus FIG. 6. To swing the central pivot head assembly 120 far to the right in FIGS. 3 and 5, cylinder 133 is retracted and pivoted on axle/axis 146 to be at about 10 degrees to the length/longitudinal axis LA of the machine, and cylinder 135 is extended and pivoted on axle/axis 147 in an opposite direction compared to cylinder 133 to be at about 30 degrees to the length/longitudinal axis of the machine. To swing the central pivot head assembly 120 far to the left in FIGS. 4 and 6, cylinder 133 is extended and pivoted on axle/axis 146 to be at about 30 degrees to the length/longitudinal axis of the machine, and cylinder 135 is retracted and pivoted in an opposite direction compared to cylinder 133 to be at about 10 degrees to the length/longitudinal axis of the machine. In certain embodiments, the horizontal pivoting of each of the cylinders 133, 135 is preferably at least 20 degrees, for example, in some embodiments 20-30 degrees, in some embodiments 20-40 degrees, or in some embodiments 30-50 degrees. Thus, the horizontally-pivotal cylinders 133, 135 may swing central pivot head assembly 120 and therefore cutting head assembly 110 side-to-side at least 120 degrees, or about 135 degrees, for example, at the front of the machine.

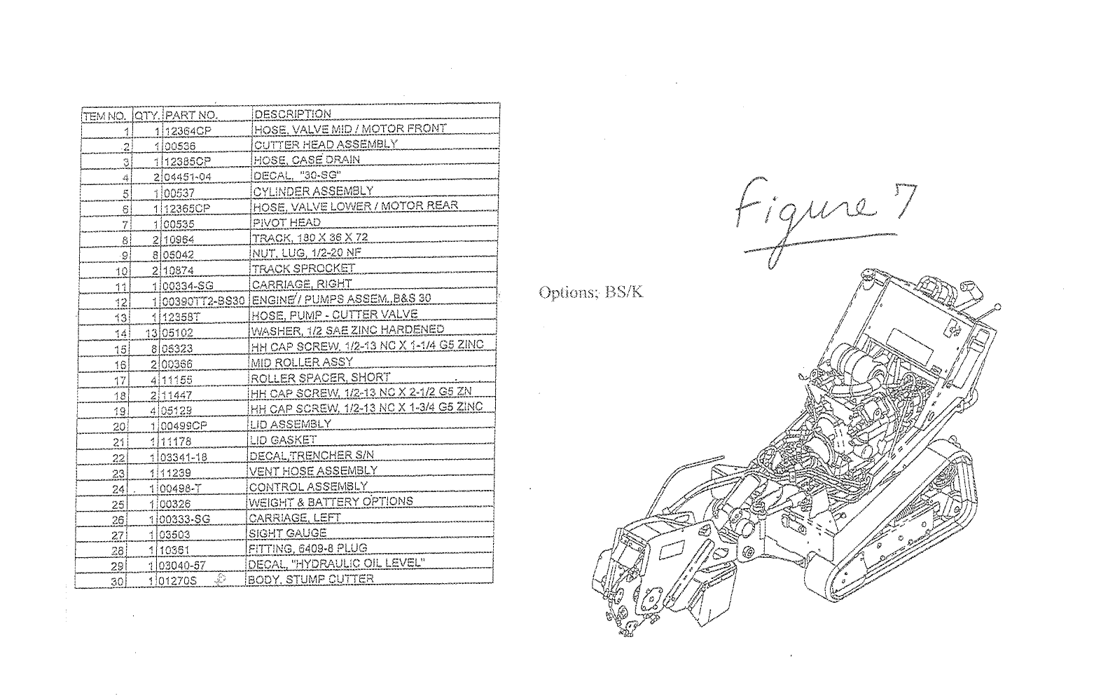

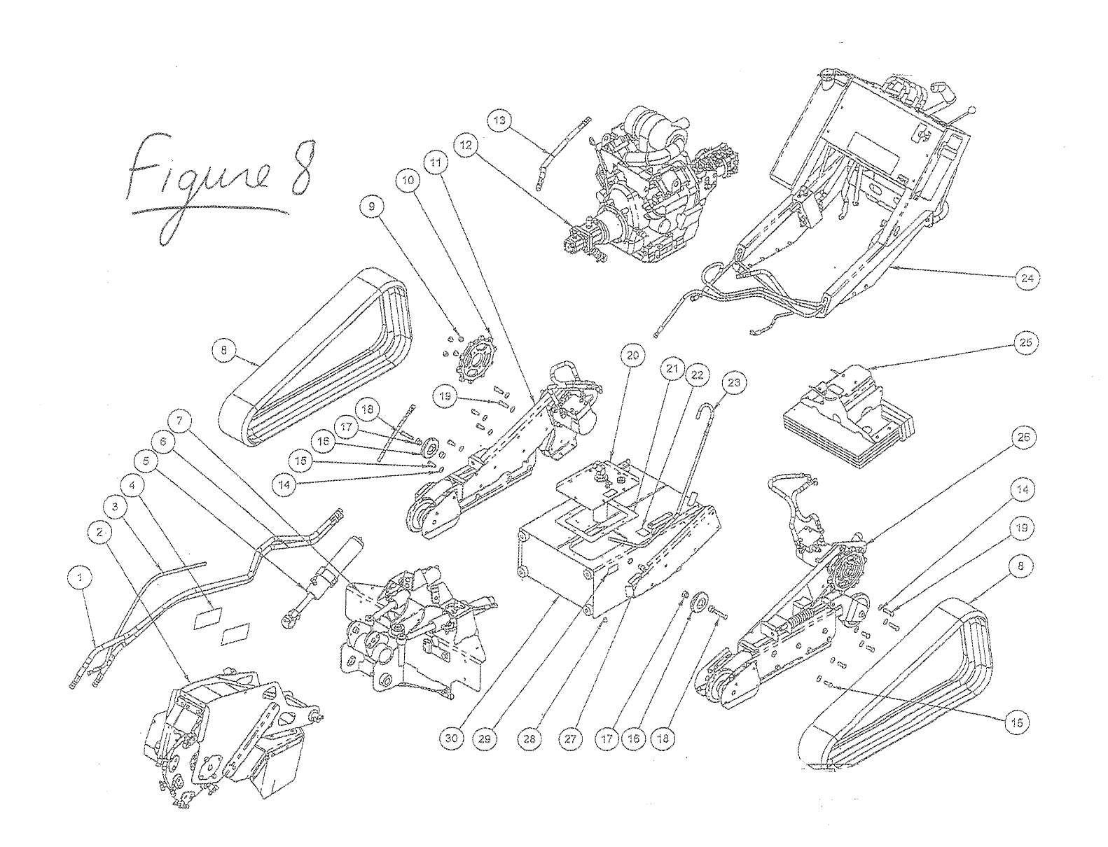

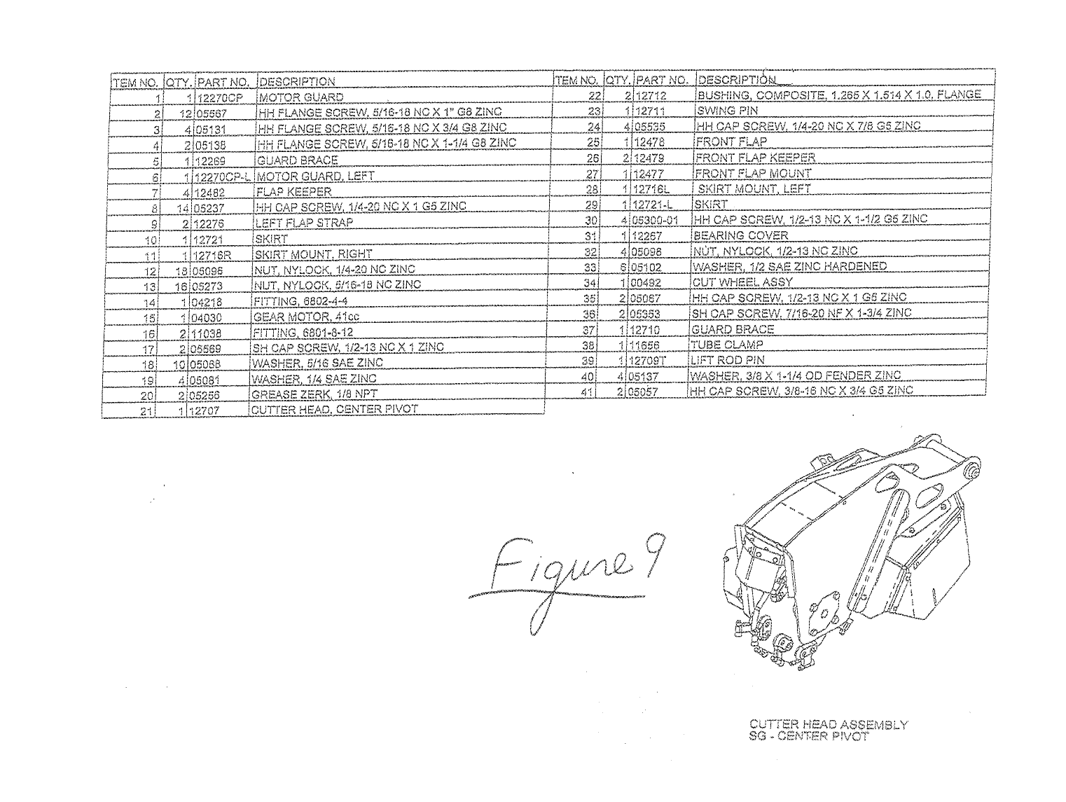

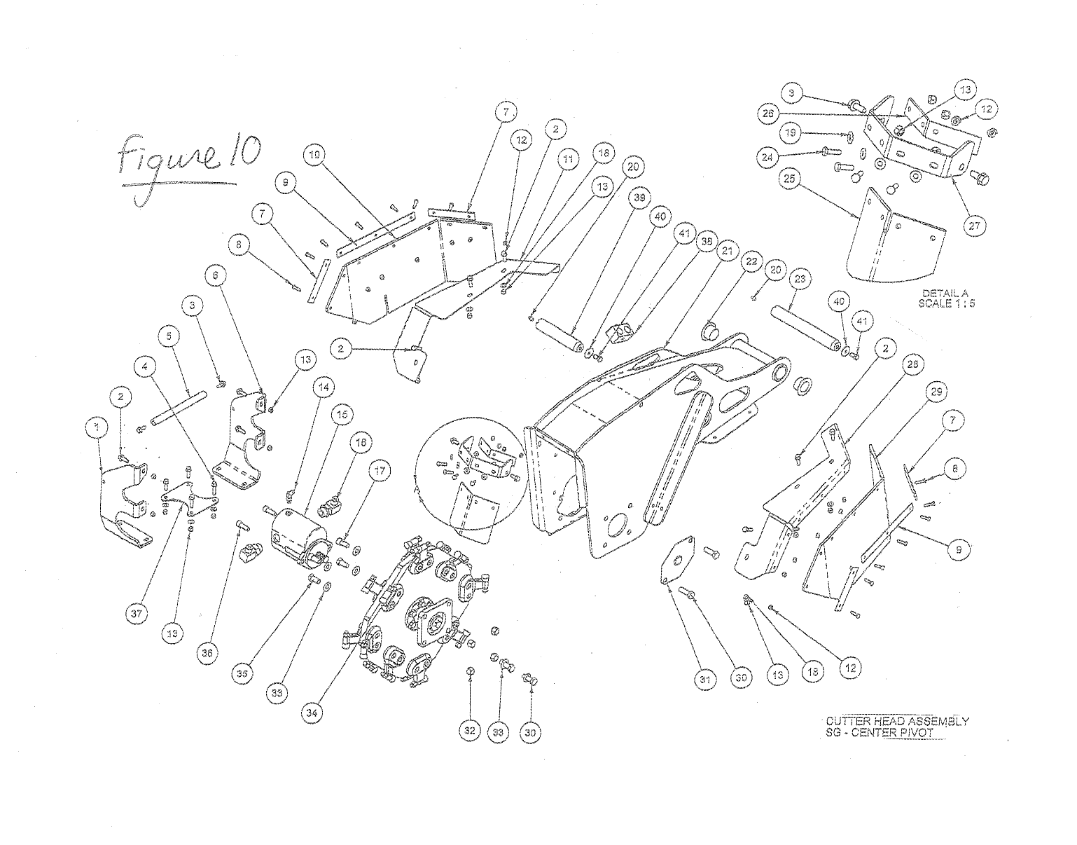

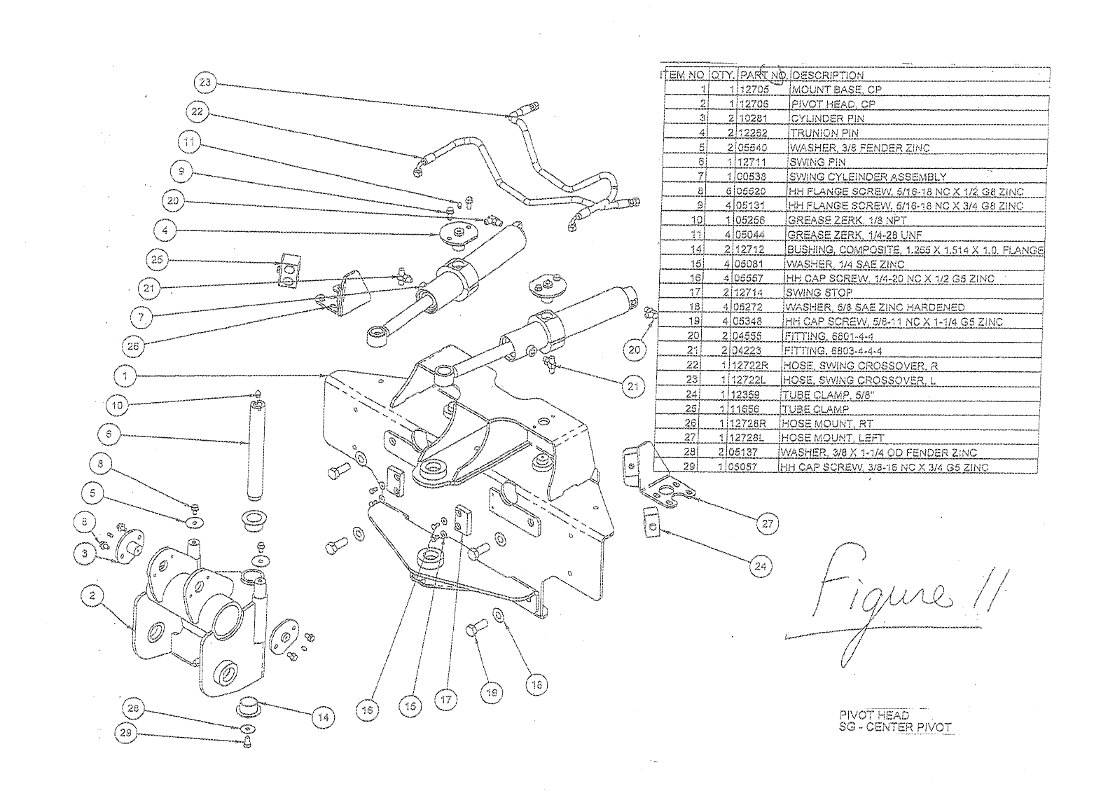

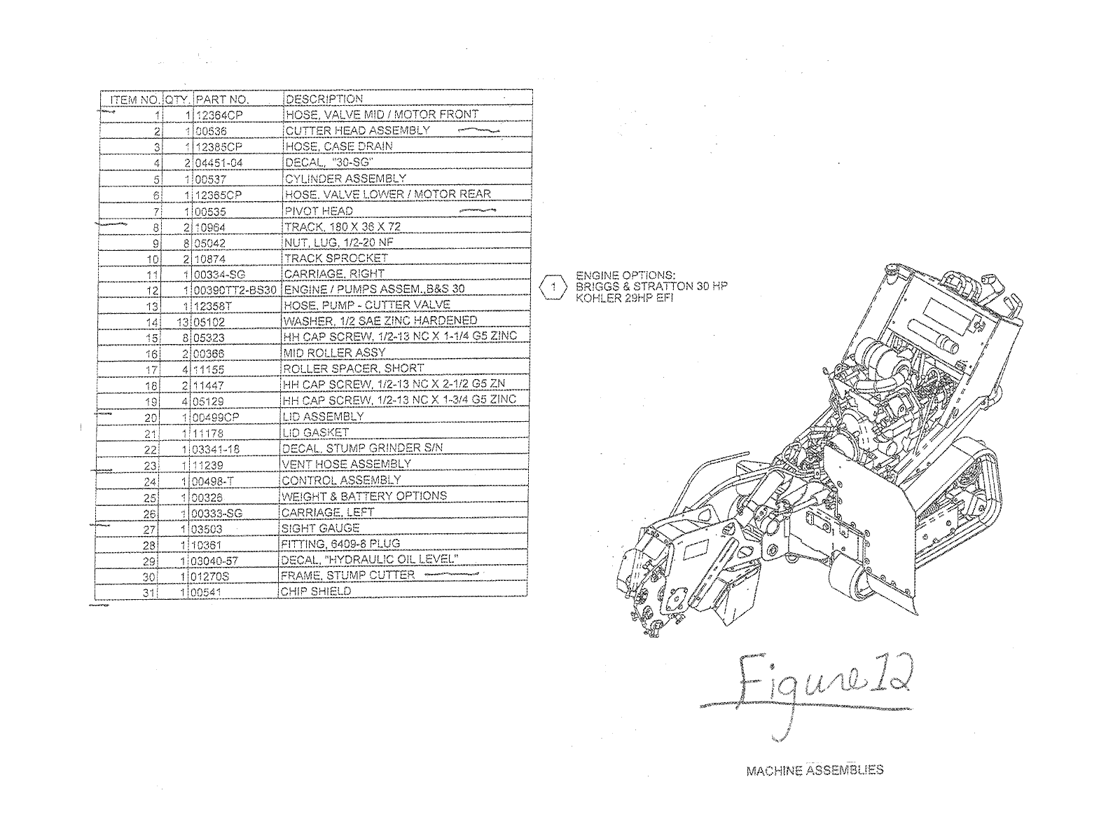

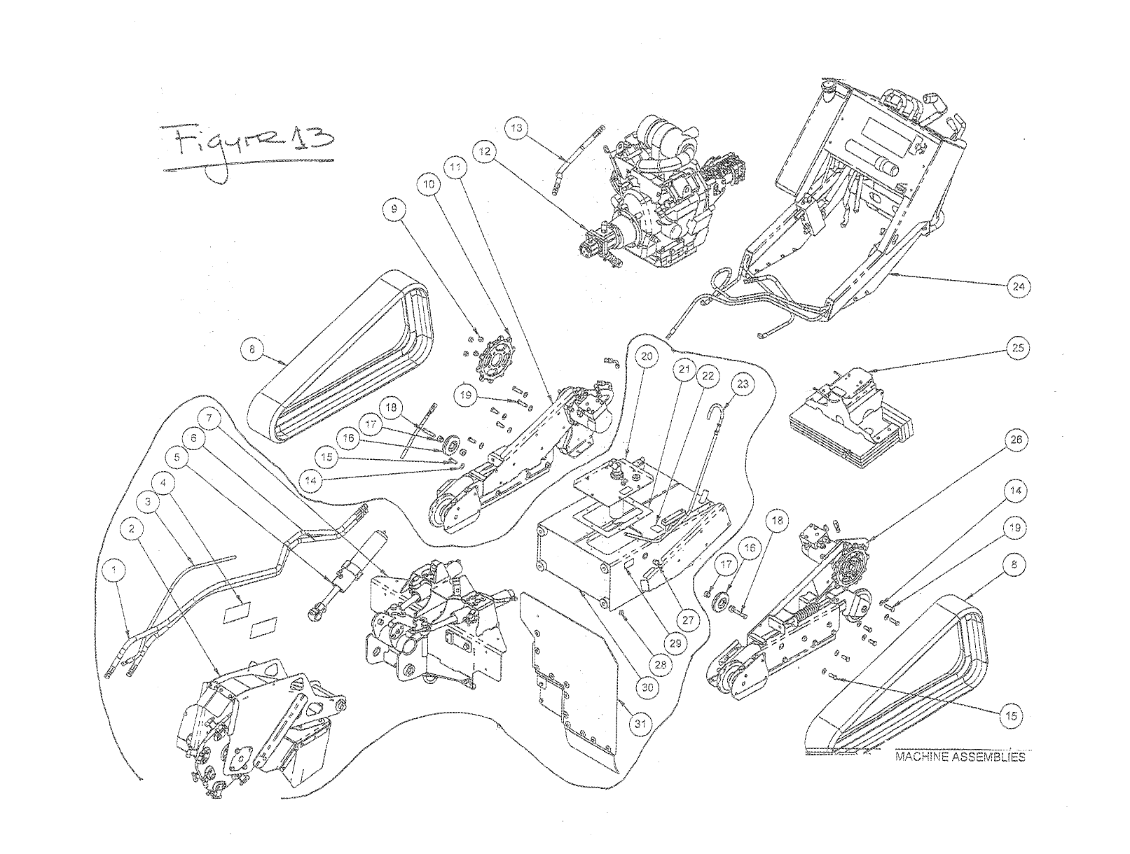

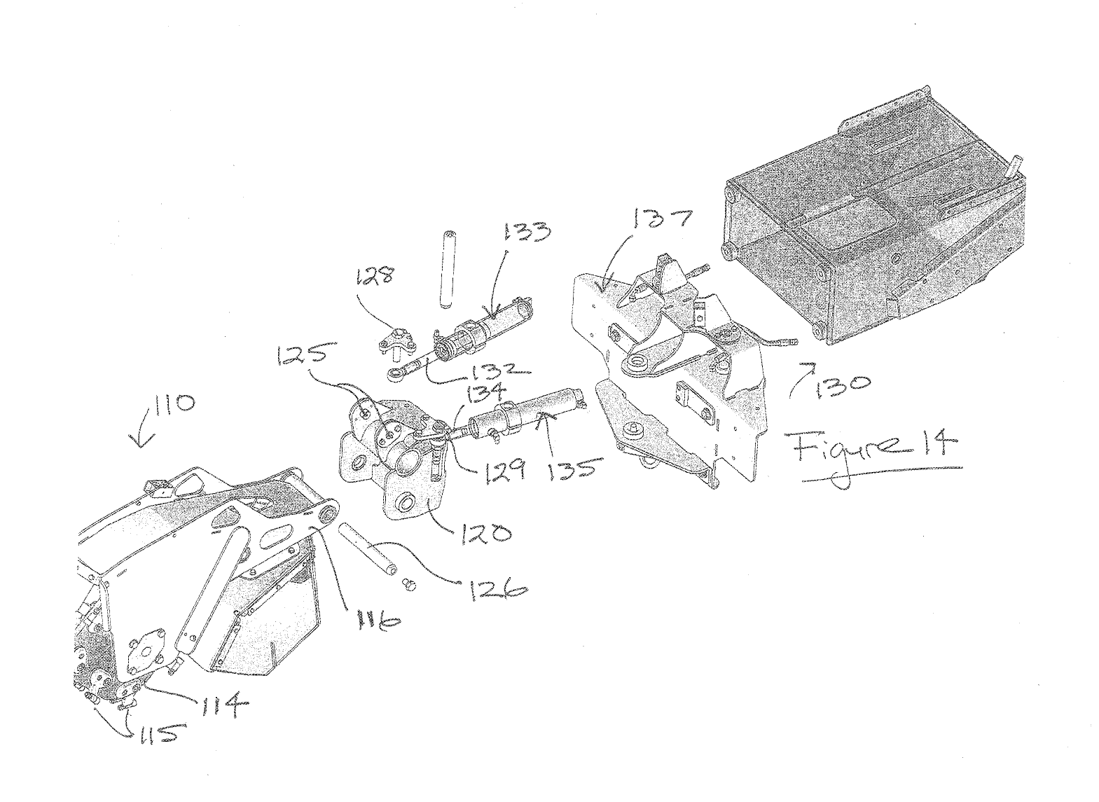

FIGS. 7-14 depict additional views of the first embodiment, discussed in detail above, and a second, similar embodiment, of the stump grinder machine. These Figures include exploded and detailed views, as well as relevant parts lists so the design and assembly of the subject machine may be completely understood.

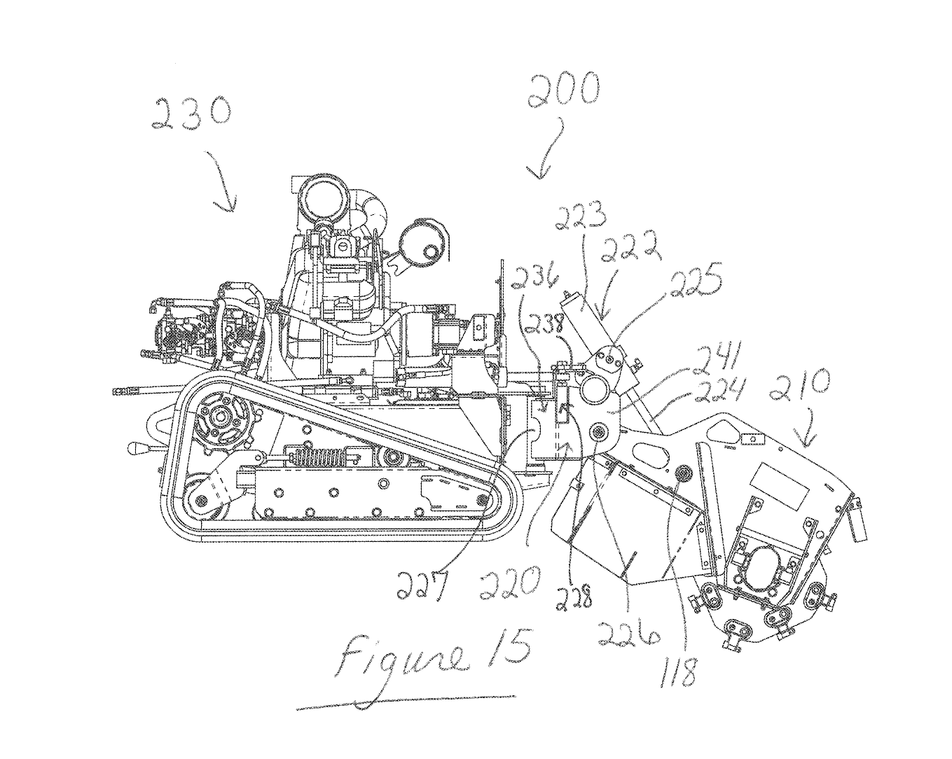

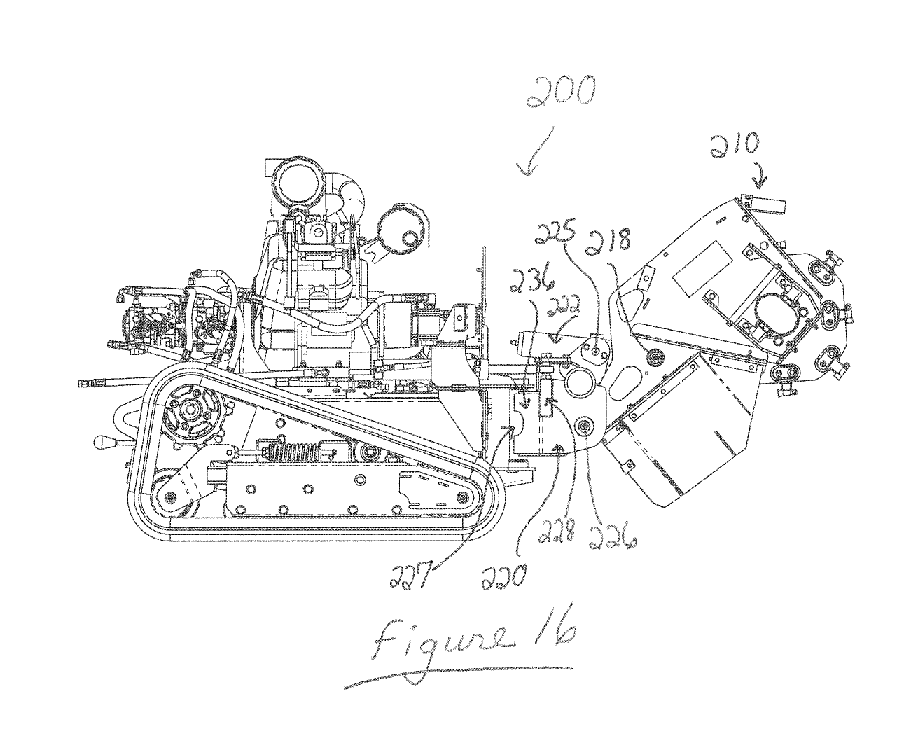

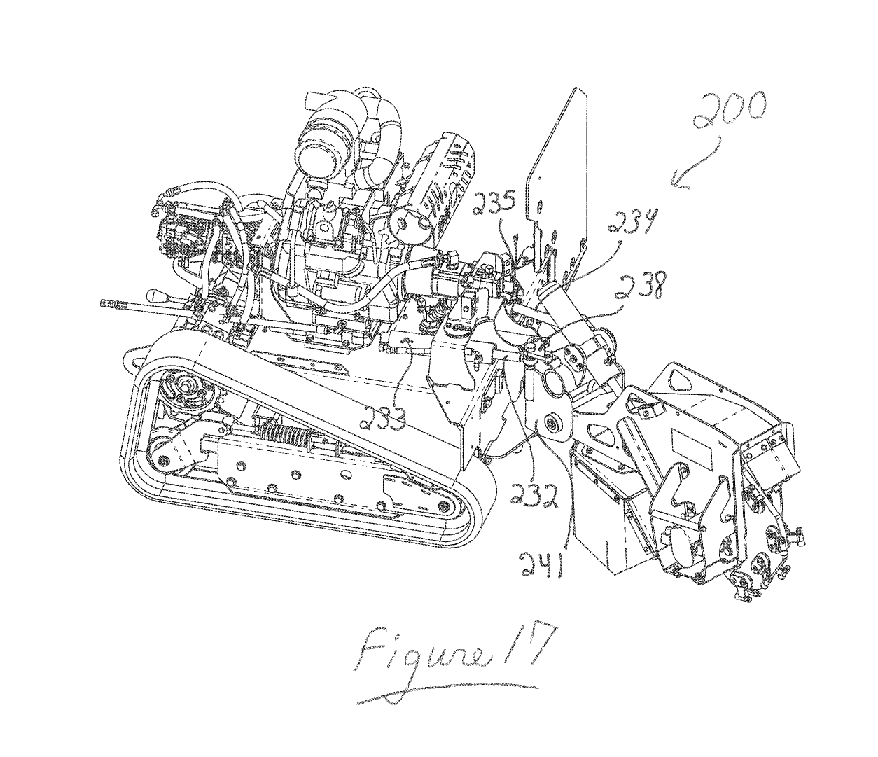

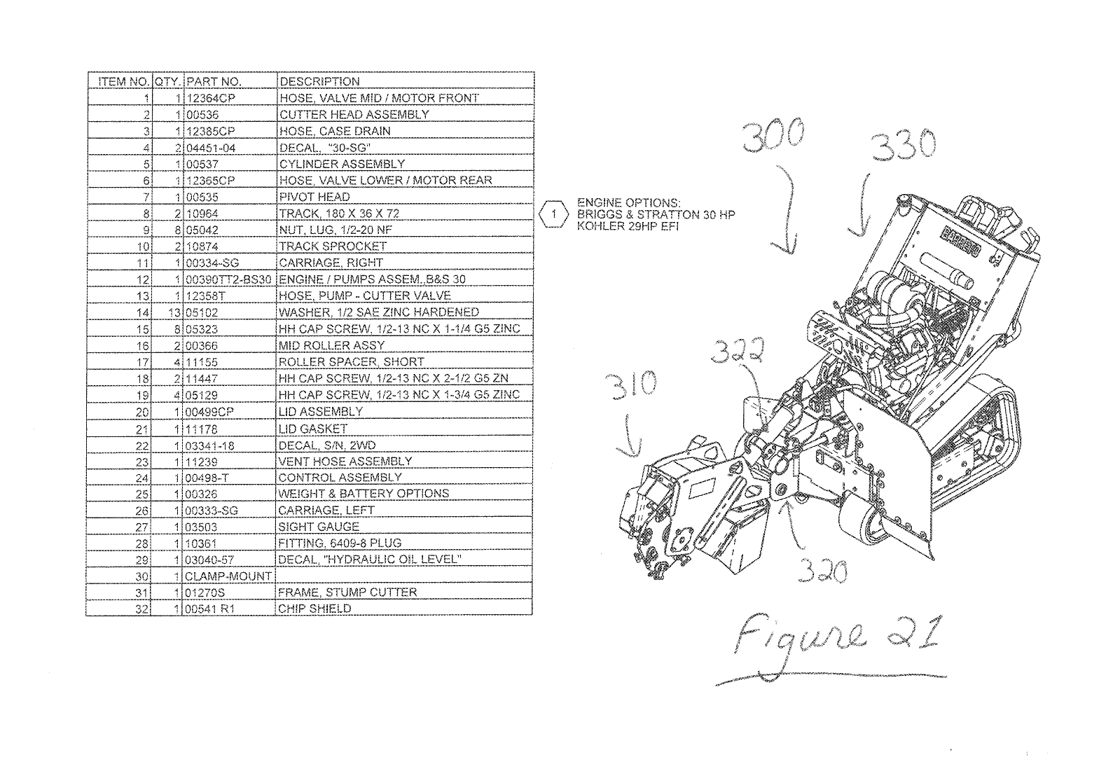

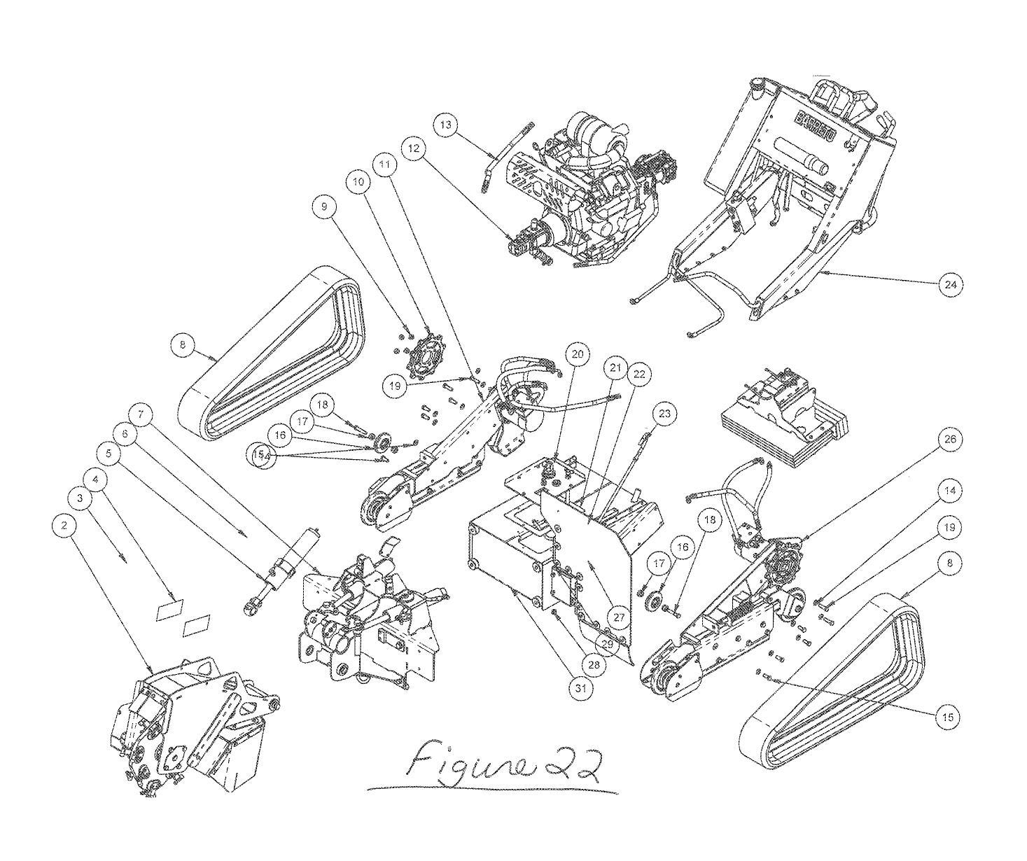

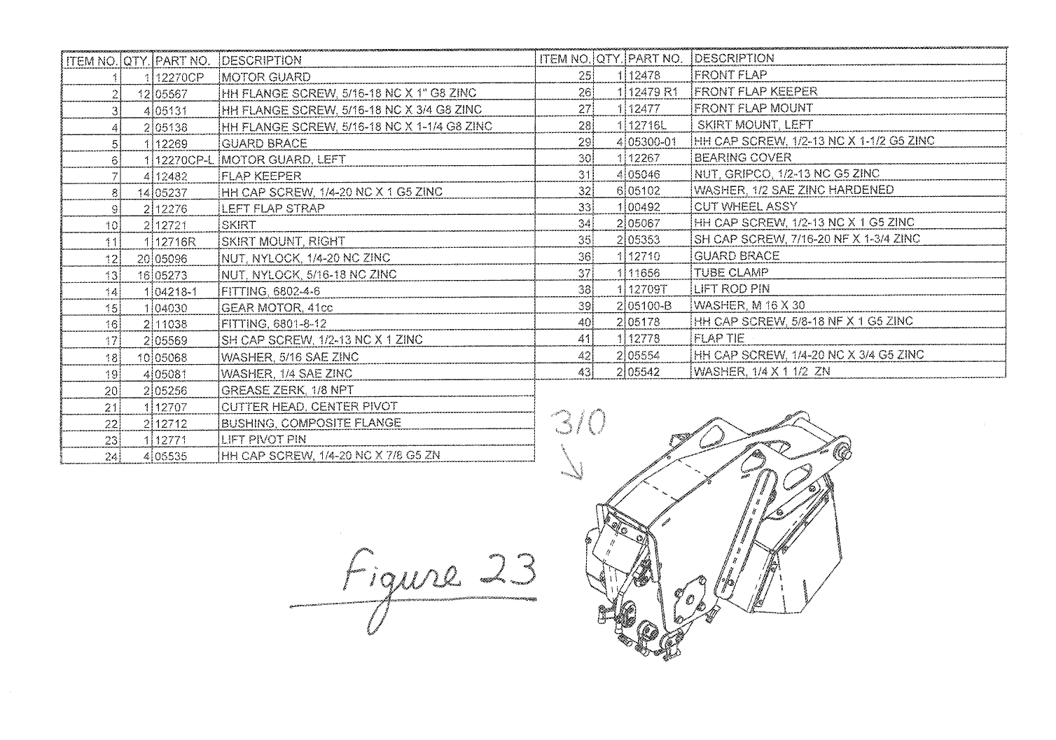

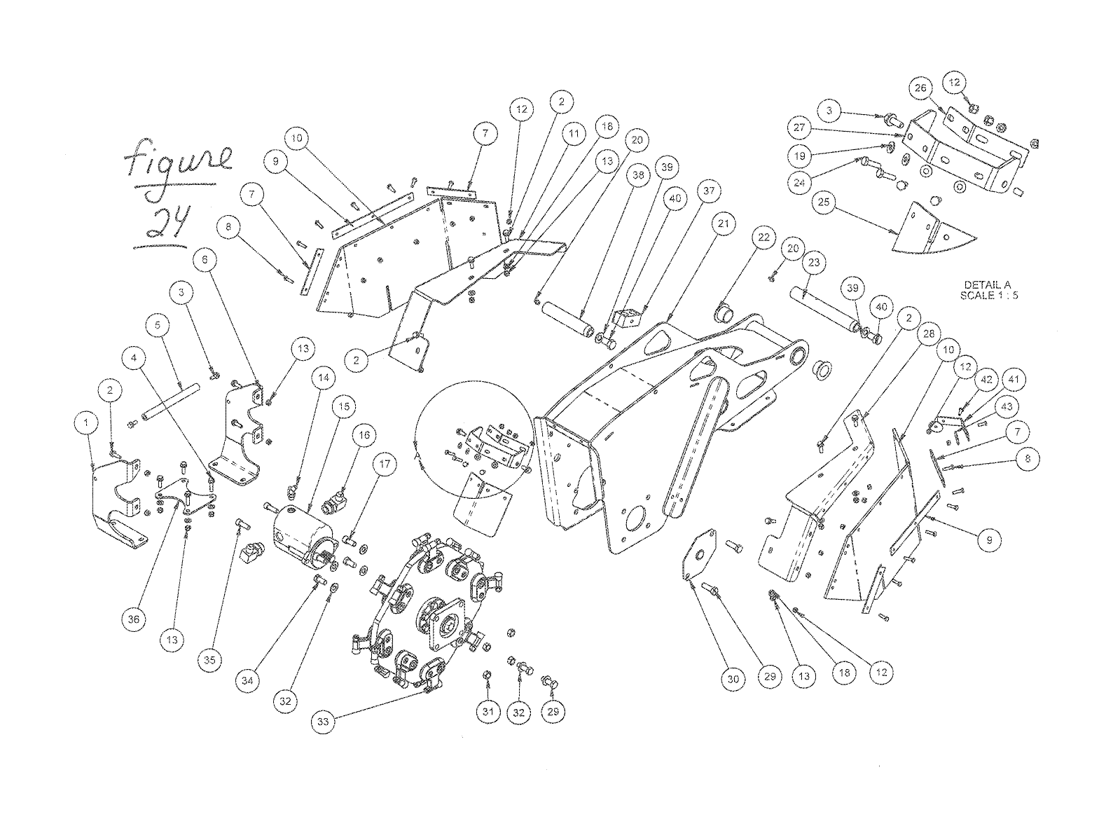

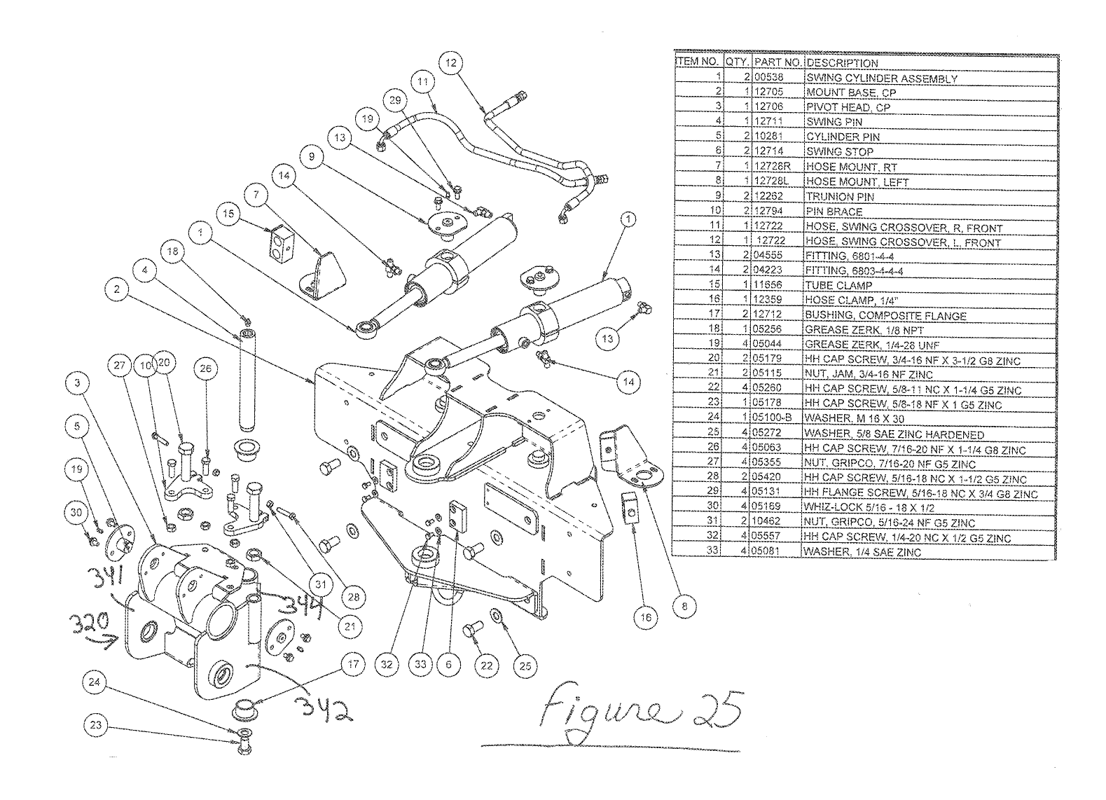

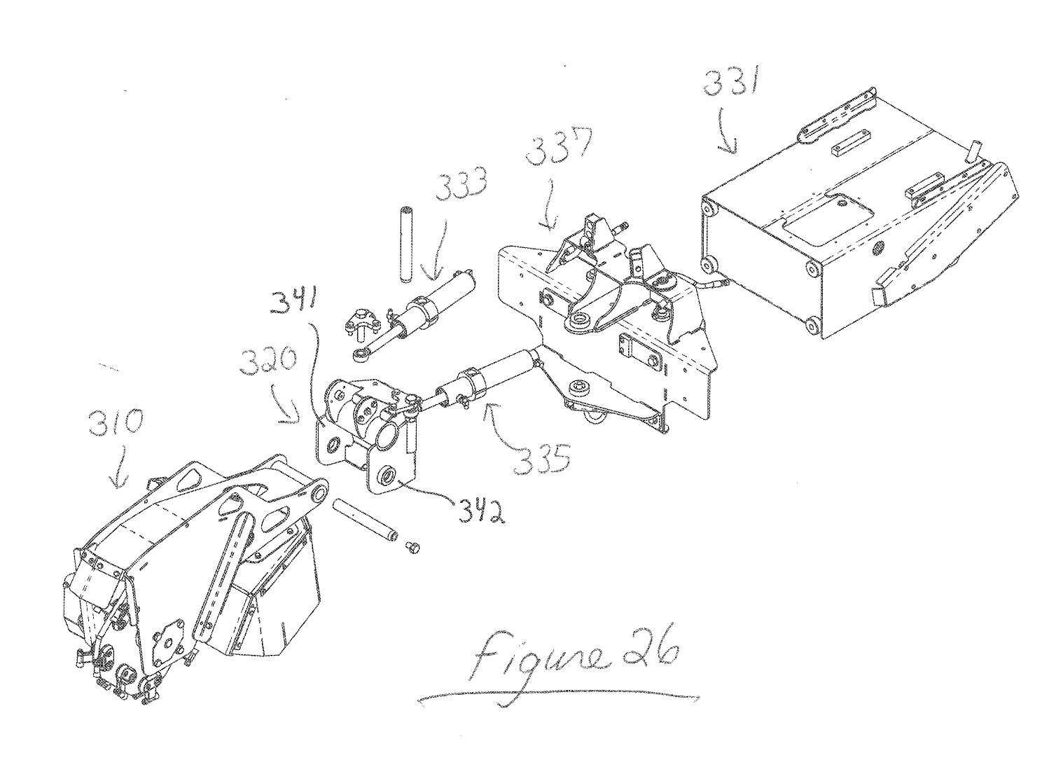

FIGS. 15-20 and FIGS. 21-26 portray additional embodiments 200 and 300, which will be understood to comprise many similar or the same structures and functions as those described for stump grinder machine 100. Machine 200 comprises cutting head assembly 210, central pivot head assembly 220, and main body 230. Trunnion-mounted cylinder 222 pivots on pivot axle/axis 225 in a vertical plane during extension and retraction, as described above for cylinder 122. Central pivot head assembly 220 comprises a front portion of right and parallel plates 241, 242, and a rear portion that is structural connector 236. Raising and lowering of the cutting head assembly 210, on pivot axle/axis 226 may be seen in FIGS. 16 and 17, as controlled by cylinder 222 extending and retracting, and the housing 223 and therefore the entire cylinder 222 including ram 224 pivoting in a horizontal plane at pivot axle/axis 225 relative to central pivot head assembly 220, with ram 224 pivoting relative to arm 216 at pivot axle/axis 118, as discussed above for stump grinder 100.

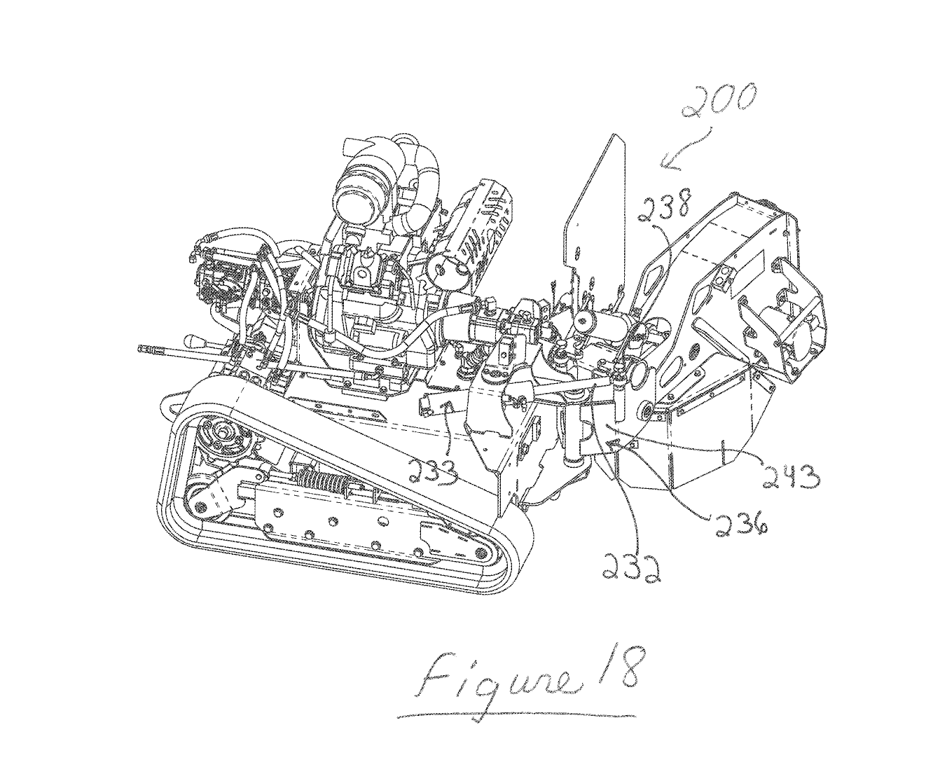

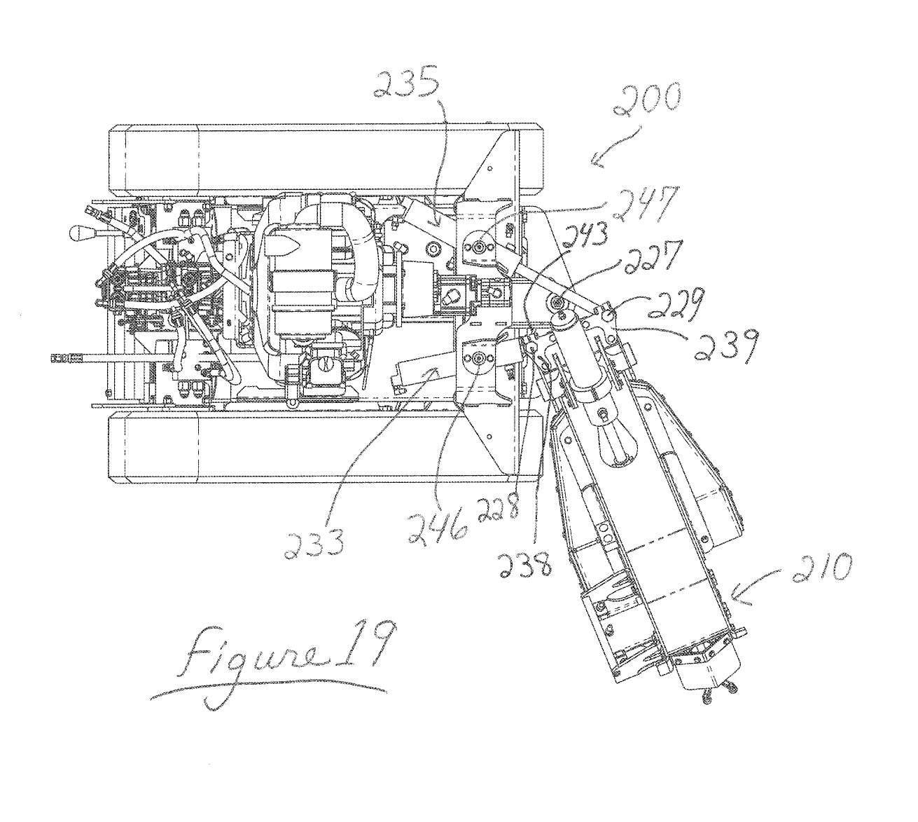

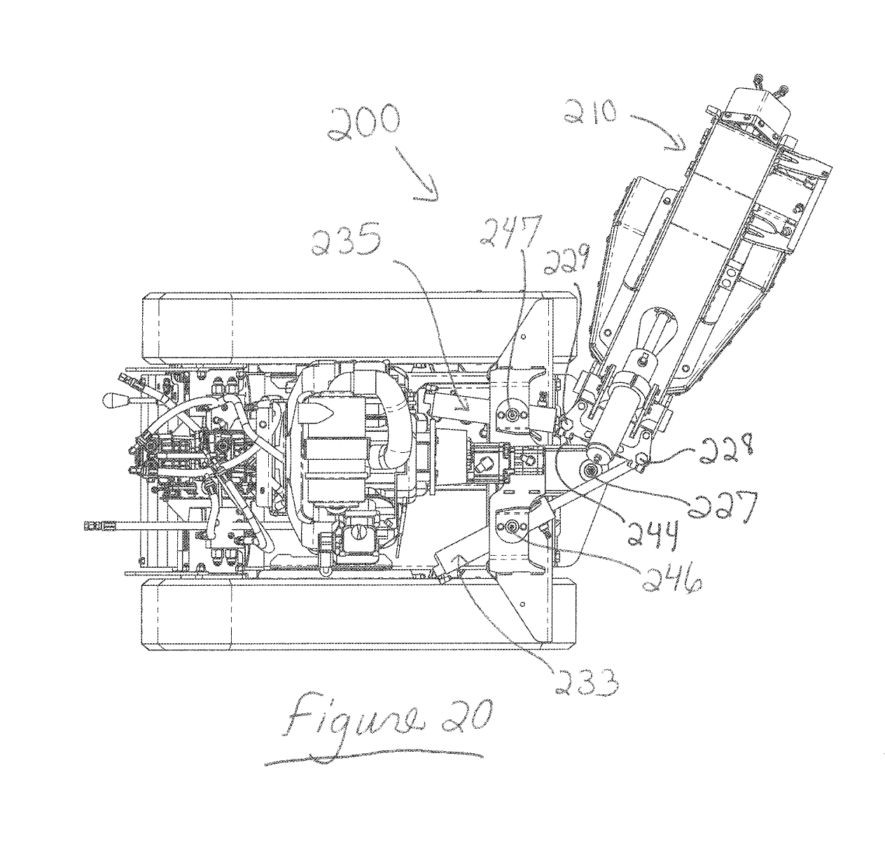

The cutting head assembly 210 and central pivot head assembly 220 may be seen to pivot laterally, side-to-side between a far right position in FIGS. 17 and 19, and a far left position in FIGS. 18 and 20. This is caused and allowed by adaptations in the structural connector 236 at the rear of central pivot head assembly 220, and in the trunnion-mounted cylinders 233, 235, similarly as discussed above for stump grinder 100.

Structural connector 236 is shaped to have outward-angled vertical side walls (or “outermost side walls”) that are close together at their read ends/edges, and divergent as they extend forward to the corners where the pivot axles/axes 228 and 229 are provided for pivotal connection of the rams of cylinders 233, 235 to the pivot head assembly 220. Thus, structural connector 236 is a triangular shape that is narrow (in width from left to right) at its rear for connection/forming pivot axle/axis 227, and wider at its front for connection/forming of pivot axles/axes 228, 229, as described above for assembly 120 and structural connector 136. The structural connector 236 may be described as a triangular shape (in top view), for example, an isosceles triangle with two equal-length plates 243, 244 at an angle to each other, for example, in the range of 80-90 degrees, or about 85 degrees as apparent from FIGS. 19 and 20. As discussed above for stump grinder 100, this adaptation allows a wide lateral swing arc because the narrow structural connector 236 swings far to the right and left without hitting a mounting plate, frame, or any portion of the main body. Note that the cylinder rams 232, 234 extend to the pivot axles/axes 228, 229 and are mounted thereto by right and left V-shaped brackets 238, 239, wherein said brackets are substantially (>95%) or entirely (100%) forward of triangular structural connector 236, and substantially (>95%) or entirely (100%) inward from the pivot axles/axes 228, 229, and therefore do not interfere with the wide lateral swing of the structural connector 236. See brackets 238, 239 in FIGS. 15, 17, 18 and 19.

The lateral cylinders 233 and 235 are trunnion-mounted on pivot axles/axes 246, 247, as discussed above, so that they pivot in horizontally planes (or a single horizontal plane) as they extend and retract, for an increased lateral-swing arc. The extension and retraction, and the pivoting to different angles relative to the length/longitudinal axis of the machine 200, may be seen to best advantage in FIGS. 19 and 20. It will be understood that the pivoting in horizontal plane(s) of the cylinders 233, 235, including their respective rams 232, 234, is continuous, for excellent control and positioning of the cutting head assembly 210 for various uses and stump positions relative to the main body 230 of the machine 200.

The components and operation of stump grinder 300 will be understood from the discussion above regarding stump grinders 100, 200, and FIGS. 1-20. The cutting head assembly 310, central pivot head assembly 320, mounting plate 337, cylinders 322, 333, 335, main body 330, structural connector 336, and frame portion 331 of the main body 330 will be understood from the above description of stump grinders 100, 200.

In the Summary of the Invention, throughout the Detailed Description, and in the accompanying drawings, reference is made to particular features, including method steps, of certain embodiments of the invention. It is to be understood that the disclosure of the invention in this specification includes all possible combinations of such particular features. For example, where a particular feature is disclosed in the context of a particular aspect, a particular embodiment, or a particular Figure, that feature can also be used, to the extent appropriate, in the context of other particular aspects, embodiments, and Figures, and in the invention generally. Further, although this disclosed technology has been described above with reference to particular means, materials and embodiments, it is to be understood that the disclosed technology is not limited to these disclosed particulars and extends instead to all equivalents within the broad scope of this disclosure and of following claims.

Although this disclosed technology has been described above with reference to particular means, materials and embodiments, it is to be understood that the disclosed technology is not limited to these disclosed particulars, but extends instead to all equivalents within the broad scope of this disclosure, including text, tables, drawings and claims.

I claim:

1. A stump grinder machine comprising:
a front cutter head assembly vertically-pivotally connected to a front part of a central pivot head assembly;
a central hydraulic cylinder having a housing and a ram, the housing being trunnion-mounted to said central pivot head assembly, and the ram pivotally connected to a central part of said cutter head assembly, so that the central hydraulic cylinder pivots in a vertical plane relative to the central pivot head assembly during expansion and retraction of the ram to raise and lower the front cutter head assembly;
the central pivot head assembly having a rear part that is a structural connector horizontally-pivotally connected on a vertical pivot axis to a front, central part of a main body of said stump grinder machine;
two generally horizontal hydraulic cylinders each trunnion-mounted to a front part of the main body of said stump grinder machine to pivot horizontally relative to said front part of the main body, the generally horizontal hydraulic cylinders each having a ram connected to said central pivot head assembly at lateral pivots located on right and left outer sides of the central pivot head assembly and forward of said structural connector, said lateral pivots being separated by a same or similar horizontal distance from said vertical pivot axis;
wherein the structural connector has outermost vertical side walls that angle outwardly from the vertical pivot axis to the lateral pivots so that the structural connector has a width between said outermost vertical side walls that is narrower at the vertical pivot axis than at the lateral pivots; and
wherein the trunnion-mounted generally horizontal hydraulic cylinders both pivot horizontally during expansion and during retraction to swing the front cutter head assembly horizontally right and left in a swing arc of greater than 120 degrees.

2. A stump grinder machine as in claim 1, wherein said front part of the main body is a mounting plate that comprises apertures and fittings for the trunnion-mounting of said generally horizontal hydraulic cylinders for said pivoting horizontally during expansion and retraction.

3. A stump grinder machine as in claim 2, wherein the mounting plate is conveniently removably connected to said grinder machine.

4. A stump grinder machine as in claim 1, wherein each of the generally horizontal hydraulic cylinders pivots horizontally during expansion and during retraction at least 20 degrees.

5. A stump grinder machine as in claim 4, wherein each of the generally horizontal hydraulic cylinders pivots horizontally during expansion and during retraction an amount in a range of 20-40 degrees.

6. A stump grinder machine as in claim 1, wherein said structural connector is triangular and has an angle between said outermost vertical side walls in the range of 70-90 degrees.

7. A stump grinder machine as in claim 4, wherein said structural connector is triangular and has an angle between said outermost vertical side walls in the range of 70-90 degrees.

8. A stump grinder machines as in claim 1, wherein the central hydraulic cylinder pivots in said vertical plane at least 45 degrees.

9. A stump grinder machine as in claim 8, wherein the central hydraulic cylinder pivots in said vertical plane at least 50 degrees.
